(19) United States
(12) Patent Application Publication
(10) Pub. No.: US 2021/0220793 A1
(43) Pub. Date: Jul. 22, 2021

(54) METHOD FOR SYNTHESIZING MAGADIITE/PMMA NANO COMPOSITE MICROSPHERES BY USING PH VALUE REGULATION IN PICKERING EMULSION

(71) Applicant: SOUTH CHINA UNIVERSITY OF TECHNOLOGY, Guangdong (CN)

(72) Inventors: Mingliang GE, Guangdong (CN); Xubin WANG, Guangdong (CN); Luoxiang CAO, Guangdong (CN)

(73) Assignee: SOUTH CHINA UNIVERSITY OF TECHNOLOGY, Guangdong (CN)

(21) Appl. No.: 17/055,613

(22) PCT Filed: Oct. 31, 2018
(86) PCT No.: PCT/CN2018/113222

§ 371 Date: Nov. 16, 2020

(30) Foreign Application Priority Data
May 15, 2018 (CN) 201810460601.9

(51) Int. Cl. B01J 13/14; C08F 120/14; C08F 2/28; C08F 2/44; C08K 3/34

(52) U.S. Cl. CPC B01J 13/14; C08F 120/14; B82Y 30/00; C08F 2/44; C08K 3/34; C08F 2/28

(57) ABSTRACT

The disclosure discloses a method for synthesizing magadiite/PMMA nano composite microspheres by using pH value regulation in a Pickering emulsion. According to the method, organic modified magadiite is used as an emulsifier, deionized water of which a pH value is regulated with a buffer solution is used as a solvent, and a methylmethacrylate monomer is used as an oil phase of a Pickering emulsion; stirring is performed to form the stable Pickering emulsion, and then a water-soluble free-radical initiator is added to initiate emulsion polymerization, thereby synthesizing magadiite/PMMA nano composite microspheres.

### BACKGROUND

### Technical Field

The present disclosure relates to the technical field of preparing magadiite/PMMA nano composite microspheres, and more particularly, to a method for synthesizing magadiite/PMMA nano composite microspheres by using pH value regulation in a Pickering emulsion.

### Description of Related Art

Emulsion polymerization is a common polymerization method to form high molecular materials via monomer polymerization, which, specifically, uses water as a water phase and a monomer as an oil phase, then the water phase and the oil phase are uniformly dispersed to form an emulsion with the help of an emulsifier and mechanical stirring, and the monomer polymerization is initiated to form a high-molecular polymer under an action of an oil-soluble or water-soluble initiator. In addition to adding the four main components including the monomer, the water, the emulsifier and the initiator, emulsions such as a buffer, an activator, a regulator, an antioxidant and the like are often added to modify properties of the polymer.

The emulsifier is a substance that forms a micelle in the emulsion polymerization, and does not participate in reaction during polymerization. However, the emulsion formed by the traditional emulsifier has a poor stability, and the micelle is easy to break during polymerization, so that a polymerization rate is limited, and molecular weight distribution of the polymer is wide. After polymerization, the emulsifier remains in products, and properties of the products are affected. Therefore, the products need to be post-processed after traditional emulsion polymerization, so that a processing cost is increased. In a Picking emulsion polymerization method, solid particles are used as an emulsion stabilizer, because a solid particle emulsifier can enable the water phase and the oil phase to form a stable oil-in-water or water-in-oil emulsion, so that a dosage of a surfactant is reduced, which further reduces impurities in final products, thereby enabling the emulsion polymerization to be more stable. Moreover, the Picking emulsion has advantages in operability, easy regulation, and other aspects.

Nano composite microspheres with different sizes have wide application fields, which not only can be used as nano materials, but also can be applied in a nano technology. For example, the nano composite microspheres may be used as carriers of clinical diagnosis and immunoassay reagents in medicine, and may form colloidal lattices serving as optical components such as a filter, an optical switch, an optical grating, an optical waveguide, a sensor, and the like; and may be used as a size standard in atomic force microscopy, electron microscopy and an electronic industry, and may also be used as efficient and durable catalyst carriers in the water phase.

As mineral clay, magadiite has a good biocompatibility, and is innocuous and harmless, and size distribution of polymer nano composite microspheres formed by mixing with polymers is narrow, so that the environment is not polluted without post-processing. An oil-in-water Picking emulsion is formed by using an organic modified magadiite solid particle emulsifier, which can effectively improve a stability of an emulsion in different pH values. On this basis, a size of the polymer nano composite microspheres is freely regulated by changing different pH values of the emulsion polymerization.

### SUMMARY

Summary

In view of the defects in the prior art, an objective of the present disclosure aims to provide a method for synthesizing magadiite/PMMA nano composite microspheres by using pH value regulation in a Pickering emulsion. According to the method, a size of Pickering emulsion droplets is specifically regulated through a pH value, so that a size of organic modified magadiite/PMMA nano composite microspheres is regulated, thereby synthesizing the magadiite/PMMA nano composite microspheres with different sizes.

The objective of the present disclosure is achieved by the following technical solution.

According to a method for synthesizing magadiite/PMMA nano composite microspheres by using pH value regulation in a Pickering emulsion, organic modified magadiite is used as an emulsifier, deionized water of which a pH value is regulated with a buffer solution is used as a solvent, and a methylmethacrylate monomer is used as an oil phase of a Pickering emulsion; stirring is performed to form the stable Pickering emulsion, and then a water-soluble free-radical initiator is added to initiate emulsion polymerization, thereby synthesizing magadiite/PMMA nano composite microspheres.

A method for synthesizing magadiite/PMMA nano composite microspheres by using pH value regulation in a Pickering emulsion includes the following steps:

(1) adding deionized water into a reaction container, adding a buffer solution to regulate a pH value, then adding organic modified magadiite, and stirring and heating to 50° C. to 80° C., so that the organic modified magadiite is uniformly dispersed in the water;

(2) cooling to 30° C. to 40° C., adding a methylmethacrylate monomer, and continuously stirring to form a uniform and stable Pickering emulsion; and

(3) heating the Pickering emulsion to 60° C. to 90° C., adding a water-soluble free-radical initiator, heating and keeping a temperature at 80° C. to 90° C., reacting for 3 hours to 5 hours, cooling to a temperature lower than 50° C., stopping stirring, drying in vacuum and grinding to obtain the magadiite/PMMA nano composite microspheres.

Preferably, in the step (1), a mass of the deionized water accounts for 50 wt % to 90 wt % of a total mass of the Pickering emulsion.

Preferably, in the step (1), the buffer solution is an HCl solution or a sodium bicarbonate solution.

Preferably, in the step (1), the pH value is regulated between 3.0 and 11.0.

Preferably, in the step (1), the organic modified magadiite includes one of magadiite modified by quaternary ammonium salt, quaternary phosphonium salt or silane.

Preferably, in the step (1), a dosage of the organic modified magadiite is 0.01 wt % to 1 wt % of a mass of the methylmethacrylate monomer.

Preferably, in the step (3), the water-soluble free-radical initiator includes persulfate.

More preferably, in the step (3), the persulfate includes potassium persulfate, sodium persulfate or ammonium persulfate.

Preferably, in the step (3), a dosage of the water-soluble free-radical initiator is 0.1 wt % to 0.5 wt % of a mass of the methylmethacrylate monomer.

Preferably, the magadiite/PMMA nano composite microspheres have a size ranging from 200 nm to 1000 nm.

Compared with the prior art, the present disclosure has the following advantages and beneficial effects:

according to the present disclosure, the use of the organic modified magadiite emulsifier solid particles greatly improves a stability of an emulsion in different pH values, achieves free regulation to the size of the nano composite microspheres, and significantly reduces the dosage of the emulsifier; a process for regulating the size of the nano composite microspheres is simple and easy to operate and has an obvious effect; and the synthesized magadiite/PMMA nano composite microspheres have uniform sizes and are environmentally friendly.

### BRIEF DESCRIPTION OF THE DRAWINGS

Brief Description of the Drawings

FIG. 1 is an infrared spectrogram of magadiite modified by dodecyltrimethylammonium bromide in Embodiment 1;

FIG. 2 is an infrared spectrogram of magadiite/PMMA nano composite microspheres synthesized in Embodiment 1;

FIG. 3 is an SEM of the magadiite/PMMA nano composite microspheres synthesized in Embodiment 1;

FIG. 4 is an SEM of magadiite/PMMA nano composite microspheres synthesized in Embodiment 2;

FIG. 5 is an SEM of magadiite/PMMA nano composite microspheres synthesized in Embodiment 3.

### DESCRIPTION OF THE EMBODIMENTS

### Description of the Embodiments

The technical solution of the present disclosure is further described in detail hereinafter with reference to the specific embodiments and the accompanying drawings, but the scope of protection and the implementations of the present disclosure are not limited to this.

### Embodiment 1

A method for synthesizing magadiite/PMMA nano composite microspheres by using pH value regulation in a Pickering emulsion included the following steps.

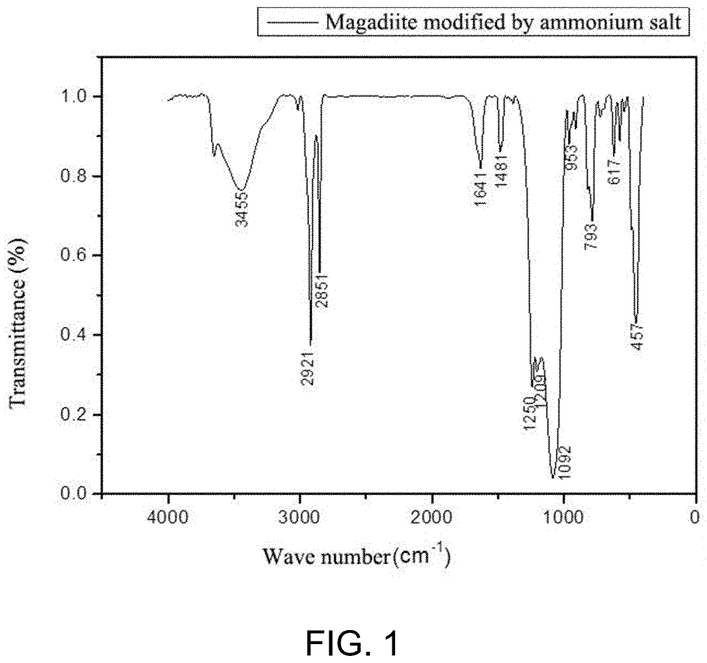

(1) Deionized water accounting for 50% of a total mass of an emulsion was added into a three-necked flask, a pH value was regulated to 3.0 by a dilute hydrochloric acid buffer solution with a concentration of 0.01 mol/L, and then magadiite modified by dodecyltrimethylammonium bromide and accounting for 0.01% of a methylmethacrylate monomer (an infrared spectrogram was shown in FIG. 1) was added, stirred, and heated to 50° C. to uniformly disperse the organic modified magadiite in the water.

(2) The solution was cooled to 30° C., and added with 50 g of methylmethacrylate monomer; then, the mixed solution was continuously stirred with a mechanical impeller to enable the mixed solution to form a uniform and stable Pickering emulsion, which was white and milky without precipitates.

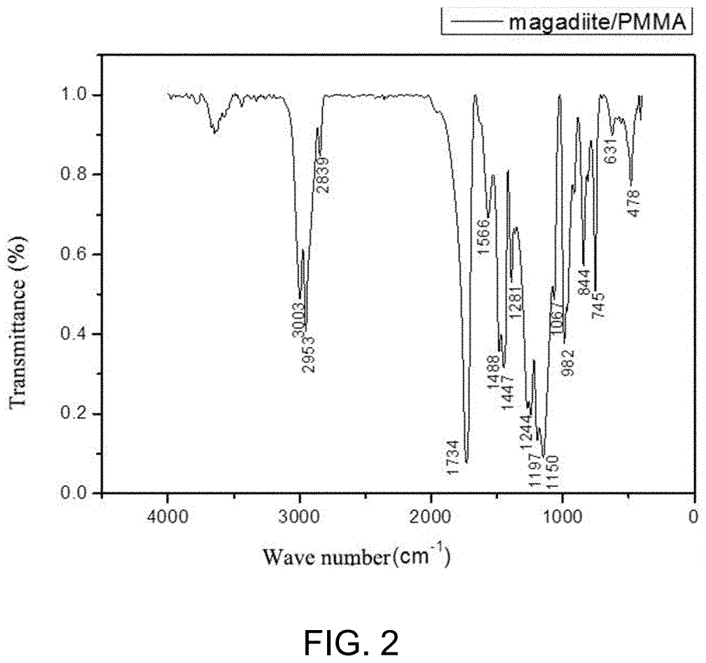

(3) The Pickering emulsion was heated to 60° C., then 0.05 g of ammonium persulfate was weighed and added into the flask through a constant pressure dropping funnel. A container was washed with deionized water after dropping, and the mixture was added into the flask. The mixture was heated to 80° C., continued to react for 3 hours, and then cooled. When a temperature of a reaction material was lower than 50° C., stirring was stopped, and a product was discharged. An infrared spectrogram of the product was shown in FIG. 2. A wave peak at 3400 cm⁻¹ was a characteristic peak of Si—OH in magadiite, and wave peaks at 3003 cm⁻¹, 2953 cm⁻¹ and 2839 cm⁻¹ were stretching vibration peaks of methyl and methylene. A wave peak at 1734 cm⁻¹ was a stretching vibration characteristic peak of C═O. Wave peaks at 1488 cm⁻¹ and 1447 cm⁻¹ were bending vibration peaks of C—H. Wave peaks at 1281 cm⁻¹, 1244 cm⁻¹, 1197 cm⁻¹ and 1150 cm⁻¹ were stretching vibration absorption peaks of C—O—C, with a peak width covering an absorption peak of the magadiite at 1000 cm⁻¹. Wave peaks at 1067 cm⁻¹ and 844 cm⁻¹ were respectively antisymmetric and symmetric stretching vibration peaks of Si—O—Si, and a wave peak at 478 cm⁻¹ was a bending vibration absorption peak of Si—O. The above confirmed that the magadiite/PMMA composite microspheres were obtained. The materials were dried in vacuum and grinded to obtain the magadiite/PMMA nano composite microspheres.

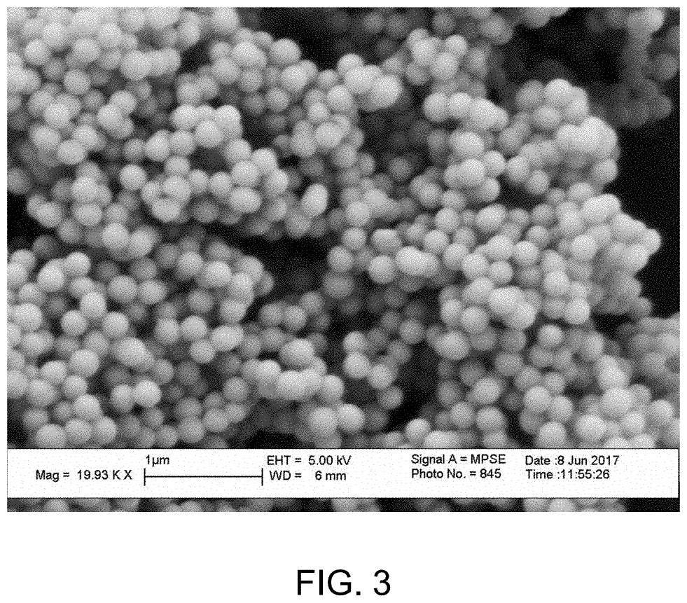

FIG. 3 shows a Scanning Electron Microscope (SEM) image of the synthesized magadiite/PMMA nano composite microspheres. It can be seen from FIG. 3 that the synthesized magadiite/PMMA nano composite microspheres have uniform sizes ranging from 200 nm to 210 nm.

### Embodiment 2

A method for synthesizing magadiite/PMMA nano composite microspheres by using pH value regulation in a Pickering emulsion included the following steps.

(1) Deionized water accounting for 70% of a total mass of an emulsion was added into a three-necked flask, a pH value was regulated to 6.0 by a sodium bicarbonate buffer solution with a concentration of 0.01 mol/L and a dilute hydrochloric acid buffer solution with a concentration of 0.01 mol/L, and then magadiite modified by hexadecyltriphenylphosphonium bromide and accounting for 0.5% of a methylmethacrylate monomer was added, stirred, and heated to 65° C. to uniformly disperse the organic modified magadiite in the water.

(2) The solution was cooled to 35° C., and added with 50 g of methylmethacrylate monomer; then, the mixed solution was continuously stirred with a mechanical impeller to enable the mixed solution to form a uniform and stable Pickering emulsion, which was white and milky without precipitates.

(3) The Pickering emulsion was heated to 75° C., then 0.15 g of ammonium persulfate was weighted and added into the flask through a constant pressure dropping funnel. A container was washed with deionized water after dropping, and the mixture was added into the flask. The mixture was heated to 85° C., continued to react for 3 hours, and then cooled. When a temperature of a reaction material was lower than 50° C., stirring was stopped, and a product was discharged. The materials were dried in vacuum and grinded to obtain the magadiite/PMMA nano composite microspheres.

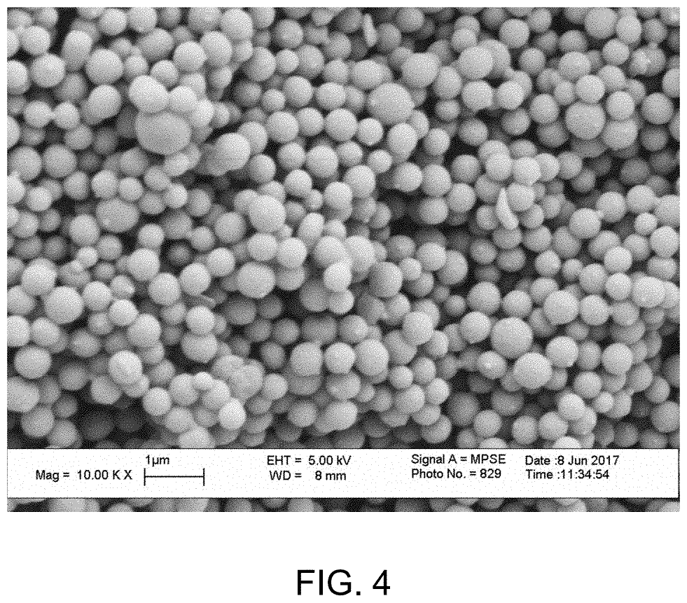

FIG. 4 shows a SEM image of the synthesized magadiite/PMMA nano composite microspheres. It can be seen from FIG. 4 that the synthesized magadiite/PMMA nano composite microspheres have uniform sizes ranging from 410 nm to 420 nm.

### Embodiment 3

A method for synthesizing magadiite/PMMA nano composite microspheres by using pH value regulation in a Pickering emulsion included the following steps.

(1) Deionized water accounting for 90% of a total mass of an emulsion was added into a three-necked flask, a pH value was regulated to 11.0 by a sodium bicarbonate buffer solution with a concentration of 0.01 mol/L, and then magadiite modified by γ-aminopropyltriethoxysilane and accounting for 1% of a methylmethacrylate monomer was added, stirred, and heated to 80° C. to uniformly disperse the organic modified magadiite in the water.

(2) The solution was cooled to 40° C., and added with 50 g of methylmethacrylate monomer; then, the mixed solution was continuously stirred with a mechanical impeller to enable the mixed solution to form a uniform and stable Pickering emulsion, which was white and milky without precipitates.

(3) The Pickering emulsion was heated to 90° C., then 0.25 g of ammonium persulfate was weighed and added into the flask through a constant pressure dropping funnel. A container was washed with deionized water after dropping, and the mixture was added into the flask. The mixture was heated to 90° C., continued to react for 3 hours, and then cooled. When a temperature of a reaction material was lower than 50° C., stirring was stopped, and a product was discharged. The materials were dried in vacuum and grinded to obtain the magadiite/PMMA nano composite microspheres.

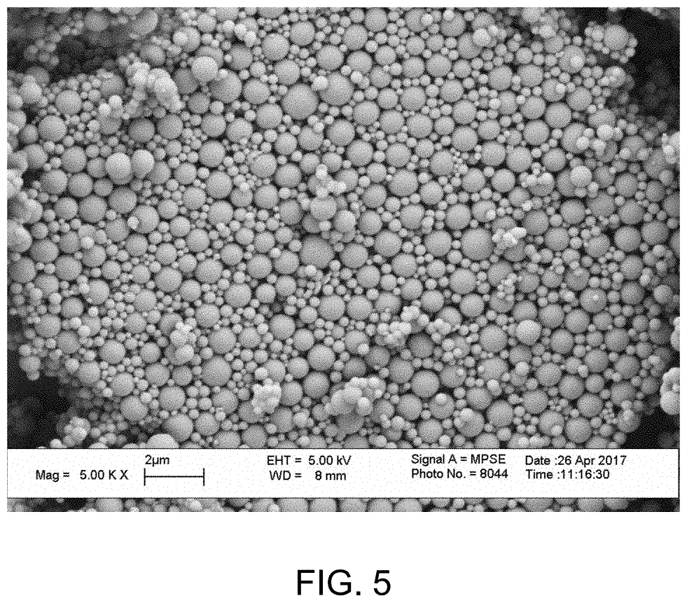

FIG. 5 shows a SEM image of the synthesized magadiite/PMMA nano composite microspheres. It can be seen from FIG. 5 that the synthesized magadiite/PMMA nano composite microspheres have uniform sizes ranging from 900 nm to 1000 nm.

The above embodiments are the preferred embodiments of the present disclosure, but the embodiments of the present disclosure are not limited by the above embodiments. Any other changes, modifications, substitutions, combinations, and simplifications made without departing from the spirit and principle of the present disclosure shall be equivalent substitute modes, and shall be included in the scope of protection of the present disclosure.

1. A method for synthesizing magadiite/PMMA nano composite microspheres by using pH value regulation in a Pickering emulsion, wherein the method comprises the following steps:
step 1: adding a deionized water into a reaction container, adding a buffer solution to regulate a pH value, then adding an organic modified magadiite, and stirring and heating to 50° C. to 80° C., so that the organic modified magadiite is uniformly dispersed in the water;
step 2: cooling to 30° C. to 40° C., adding a methylmethacrylate monomer, and continuously stirring to form a uniform and stable Pickering emulsion; and
step 3: heating the Pickering emulsion to 60° C. to 90° C., adding a water-soluble free-radical initiator, heating and keeping a temperature at 80° C. to 90° C., reacting for 3 hours to 5 hours, cooling to a temperature lower than 50° C., stopping stirring, drying in vacuum and grinding to obtain the magadiite/PMMA nano composite microspheres.

2. The method according to claim 1, wherein in the step 1, a mass of the deionized water accounts for 50 wt % to 90 wt % of a total mass of the Pickering emulsion.

3. The method according to claim 1, wherein in the step 1, the buffer solution is an HCl solution or a sodium bicarbonate solution.

4. The method according to claim 1, wherein in the step 1, the pH value is regulated between 3.0 and 11.0.

5. The method according to claim 1, wherein in the step 1, the organic modified magadiite comprises one of magadiite modified by quaternary ammonium salt, quaternary phosphonium salt or silane.

6. The method according to claim 1, wherein in the step 1, a dosage of the organic modified magadiite is 0.01 wt % to 1 wt % of a mass of the methylmethacrylate monomer.

7. The method according to claim 1, wherein in the step 3, the water-soluble free-radical initiator comprises persulfate; and the persulfate comprises potassium persulfate, sodium persulfate or ammonium persulfate.

8. The method according to claim 1, wherein in the step 3, a dosage of the water-soluble free-radical initiator is 0.1 wt % to 0.5 wt % of a mass of the methylmethacrylate monomer.

9. The method according to claim 1, wherein the magadiite/PMMA nano composite microspheres have a particle size ranging from 200 nm to 1000 nm.
